(19) United States
(12) Patent Application Publication
(10) Pub. No.: US 2012/0008314 A1
(43) Pub. Date: Jan. 12, 2012

(54) LED LIGHT TUBE AND METHOD OF MANUFACTURING LED LIGHT TUBE

(75) Inventors: David Simon, Grosse Pointe Woods, MI (US); John Ivey, Farmington Hills, MI (US)

(73) Assignee: ALTAIR ENGINEERING, INC., Troy, MI (US)

(21) Appl. No.: 13/172,910

(22) Filed: Jun. 30, 2011

Related U.S. Application Data
(60) Provisional application No. 61/362,561, filed on Jul. 8, 2010.

(51) Int. Cl. F21V 15/01; H01S 4/00

(52) U.S. Cl. 362/217.1; 29/592.1

(57) ABSTRACT

An LED light tube and method of manufacturing an LED light tube includes the steps of forming an LED light tube housing of a first housing segment joined to a first end cap. One end of a circuit board is inserted through the one housing segment into contact with the first end cap. One or more additional housing segments are slid over the circuit board into engagement with ends of previously mounted housing segments. A second end cap is joined to the engaged ends of the multiple housing segments are fixed together to complete a unitary housing.

### CROSS REFERENCE TO RELATED APPLICATION

This application claims priority to U.S. Provisional Patent Application No. 61/362,561, filed Jul. 8, 2010, which is incorporated herein by reference in its entirety.

### BACKGROUND

The present LED light tube and manufacturing method relates to a light emitting diode (LED) based light tube usable in a fluorescent light fixture and methods of manufacturing the LED light tube.

LED-based light tubes have been developed for use in fluorescent light fixtures in place of conventional fluorescent tubes. LEDs have many advantages over fluorescent tubes. LEDs are more efficient, last longer, and are less sensitive to vibrations and low temperatures. To take advantage of the benefits of LEDs, LEDs are being included in lights of various shapes, such as in the shape of fluorescent tubes. LED-based light tubes, by definition, include one or more LED positioned on a circuit board. The light tubes for use in the fluorescent light fixtures are sized in length to fit the existing fixtures, and accordingly, have a considerable length. The circuit board and LEDs, along with other components, are inserted through the length of the tube during manufacture.

### SUMMARY

Disclosed herein are LED based light tubes usable in a fluorescent light fixture and methods of manufacturing the LED light tubes. One embodiment of a LED-based light for replacing a conventional fluorescent light bulb in a fluorescent light fixture includes a housing having multiple segments of equal diameter, a circuit board, and at least one LED mounted on the circuit board. The circuit board and LED's are located in an interior a cavity formed by the multiple segments of the housing being placed end to end.

One embodiment of a method of manufacturing a LED-based light mountable on a fluorescent light fixture includes the steps of providing a housing segment having a first end cap on one end and an open end; inserting a circuit board through the open end until it contacts the end cap; sliding at least one additional housing segment individually over the circuit board until an entire length of the circuit board is enclosed; placing a second end cap on a remaining open end of the last housing segment; and joining seams created between the housing segments.

In another embodiment, a method of manufacturing an LED-based light mountable in a fluorescent light fixture include the steps of coupling a first open end of one housing segment to the first end cap; engaging at least one additional housing segment to an opposite end of the one housing segment until a desired overall housing length is achieved, inserting a circuit board within an interior cavity formed by the housing segments into engagement with the first end cap; coupling a second end cap to the end of the last housing segment and to the circuit board; and fixedly joining ends of the housing segments to form a unitary housing.

### BRIEF DESCRIPTION OF THE DRAWINGS

The description herein makes reference to the accompanying drawings wherein like reference numerals refer to like parts throughout the several views, and wherein:

FIG. 1 is a perspective view of an embodiment of an assembled LED light tube;

FIG. 2 is a perspective expanded view of the LED light tube of FIG. 1 prior to assembly;

FIG. 3 is a perspective view of another embodiment of an assembled LED light tube;

FIG. 4 is a perspective expanded view of the LED light tube of FIG. 3 prior to assembly;

FIG. 5 is an exploded view of an end of the light tubes of FIGS. 1 and 3; and

FIG. 6 is a cross sectional view of an alternative embodiment of a LED light tube.

### DETAILED DESCRIPTION

LED-based replacement lights for replacing conventional fluorescent light bulbs in a fluorescent fixture are typically made with a single tubular housing within which components of the light, such as a circuit board and LEDS, are inserted. The single housings typically have a length of approximately 48″, with diameters of 0.625″, 1.0″, or 1.5″ for engagement with common fluorescent fixtures. Currently, the components of the light are inserted into an end of the single housing and must be fed through the entire housing until the components span the length of the housing.

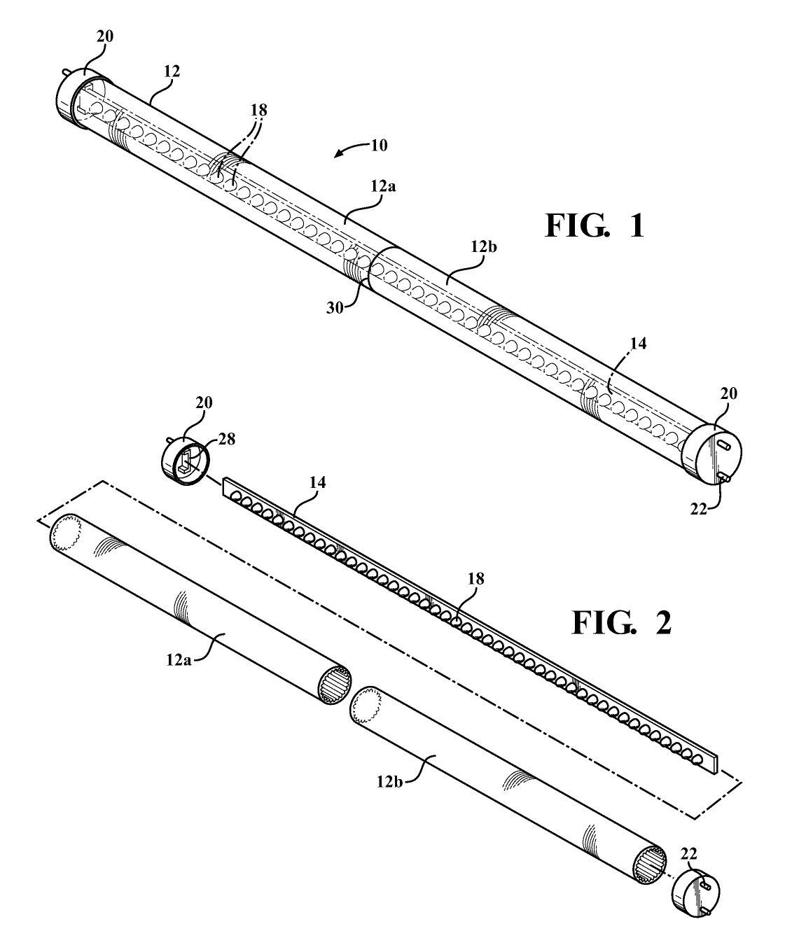

The embodiments of the housings disclosed herein are in multiple segments, thereby easing manufacture of the lights and providing more design options. Non-limiting examples of lights with the housings disclosed herein are illustrated in FIGS. 1-4. In the example illustrated in FIGS. 1 and 2, an LED-based light tube 10 is configured as a replacement for a fluorescent tube in a fluorescent fixture. The light tube 10 includes a housing 12, a circuit board 14 in the housing 12, a plurality of LEDs 18 mounted on the circuit board 14, and a pair of end caps 20 attached at opposing ends of the housing 12. The light tube 10 can additionally include other components, such as electrical components or one or more highly thermally conductive structures for enhancing heat dissipation. The lights described herein are presented as examples and are not meant to be limiting. The embodiments of the housings disclosed herein can be used with any internal light components known to those skilled in the art compatible with the scope of the disclosure.

The circuit board 14 is not limited to the example shown in the figures. The circuit board 14 can have a LED-mounting side and a primary heat transferring side opposite the LED-mounting side. The circuit board 14 may have an LED-mounting side with apertures along the circuit board to allow light to pass through. The circuit board 14 may be made in one piece or in longitudinal sections joined by electrical bridge connectors. The circuit board 14 and the housing 12 can be in thermally conductive relationship with the circuit board 14 by attachment to the housing 12 using highly thermally conductive adhesive transfer tape. The circuit board 14 can alternatively be positioned in a thermally conductive relationship with the housing 12 by attaching the circuit board 14 to the housing 12 using screws, glue, a friction fit, and other attachments known to those of skill, in which cases thermal grease can be applied between the circuit board 14 and the housing 12. The circuit board 14 is preferably one on which metalized conductor patterns can be formed in a process called “printing” to provide electrical connections from connectors 22 on the end caps 20 to the LEDs 18 and between the LEDs 18 themselves. An insulative board is typical, but other circuit board types, e.g., metal core circuit boards, can alternatively be used.

The LEDs 18 can be surface-mount devices of a type available from Nichia, although other types of LEDs can alternatively be used. For example, although surface-mounted LEDs 18 are shown, one or more organic LEDs can be used in place of or in addition thereto. Each LED 18 can include a single diode or multiple diodes, such as a package of diodes producing light that appears to an ordinary observer as coming from a single source. The LEDs 18 can be mounted to the circuit board 14 at longitudinally spaced apart locations along a central portion of the circuit board 14 as shown in FIGS. 1 and 2. In other examples, however, the LEDs 18 can be mounted at other locations. For example, LEDs 18 can be mounted in two longitudinally extending rows on opposing longitudinal sides of the circuit board 14.

The LEDs 18 can emit white light. However, LEDs that emit blue light, ultra-violet light or other wavelengths of light can be used in place of or in combination with white light emitting LEDs 18. The number of LEDs 18 can be a function of the desired lumen output of the light tube 10 and the power of the LEDs 18. For a 48″ light, the number of LEDs 18 can vary from about five to four hundred such that the light tube 10 outputs approximately 500 to 3,000 lumens. However, a different number of LEDs 18 can alternatively be used, and the light tube 10 can output any other amount of lumens. The LEDs 18 can be evenly spaced along the circuit board 16, and the spacing of the LEDs 18 can be determined based on, for example, the light distribution of each LED 18 and the number of LEDs 18.

The end caps 20 can be attached at opposing longitudinal ends of the housing 12 for physically and electrically connecting the light tube 10 to a fixture. The end caps 20 can be the sole physical connection between the bulb 10 and the fixture. The end caps 20 can be electrically connected to the circuit board 14 for providing power to the LEDs 18. Each end cap 20 can include two pins 22, although two of the total four pins can be “dummy pins” that do not provide an electrical connection. Alternatively, other types of electrical connectors can be used, such as an end cap carrying a single pin. Also, while the end caps 20 are shown as including cup-shaped bodies, the end caps 20 can have a different configuration (e.g., the end caps 20 can be shaped to be press fit into the ends of the housing 12). One or both of the end caps 20 can additionally include electric components, such as a rectifier and a filter.

The housing 12 can be formed by connecting multiple individual parts, not all of which need be light transmitting. As shown in FIGS. 1-4, the housing 12 can be provided in two segments 12a and 12b, or in three segments 12a, 12b and 12c or more. These are provided as examples and are not meant to be limiting. Any number and sizes of segments can be formed as desired or required.

For example, all of the housing segments may have the same length or one or more of the housing segments can have a different, non-equal length from the other housing segments. One or all of the housing segments may have a constant diameter linear shape between the opposed first and second ends. One or more of the housing segments of all of the housing segments used to form a single unitary housing, can have a non-linear shape, such as an arcuate or U-shape. This will enable the housing to have an overall U-shape formed of one or more arcuate or U-shaped segments joined to one or more linear segments at opposite ends of the one or more arcuate or U-shaped segments.

All of the housing segments may have a non-linear shape, such as an arcuate shape sized to form a circular housing.

The housing segments 12a, 12b, 12c can be made from polycarbonate, acrylic, glass or another light transmitting material (i.e., the housing segments can be transparent or translucent). For example, a translucent housing segment can be made from a composite, such as polycarbonate with particles of a light refracting material interspersed in the polycarbonate. While the illustrated housing segments 12a, 12b, 12c are cylindrical, the housing segments can alternatively have a square, triangular, polygonal, or other cross sectional shape. Similarly, while the illustrated housing segments 12a, 12b, 12c are linear, the overall housing 12 can have an alternative shape, e.g., a U-shape or a circular shape, making the housing segments 12a, 12b, 12c non-linear. The housing segments 12a, 12b, 12c can be manufactured to include light diffusing or refracting properties, such as by surface roughening or by applying a diffusing film to the housing 12.

The light diffusing and/or refracting properties of the housing segments 12a, 12b, 12c can vary between segments or about the circumference of the individual segments 12a, 12b, 12c. For example, housing segment 12a can be configured to provide greater light diffusion or refraction than the other housing segments 12b and 12c. This can be accomplished by, for example, increasing an amount of surface roughening on housing segment 12a compared to the other housing segments 12b, 12c, by applying different diffusing film to housing segment 12a than the other housing segments 12b, 12c, or by attaching one or more reflectors to the housing segment 12a over at least portions of its surface area.

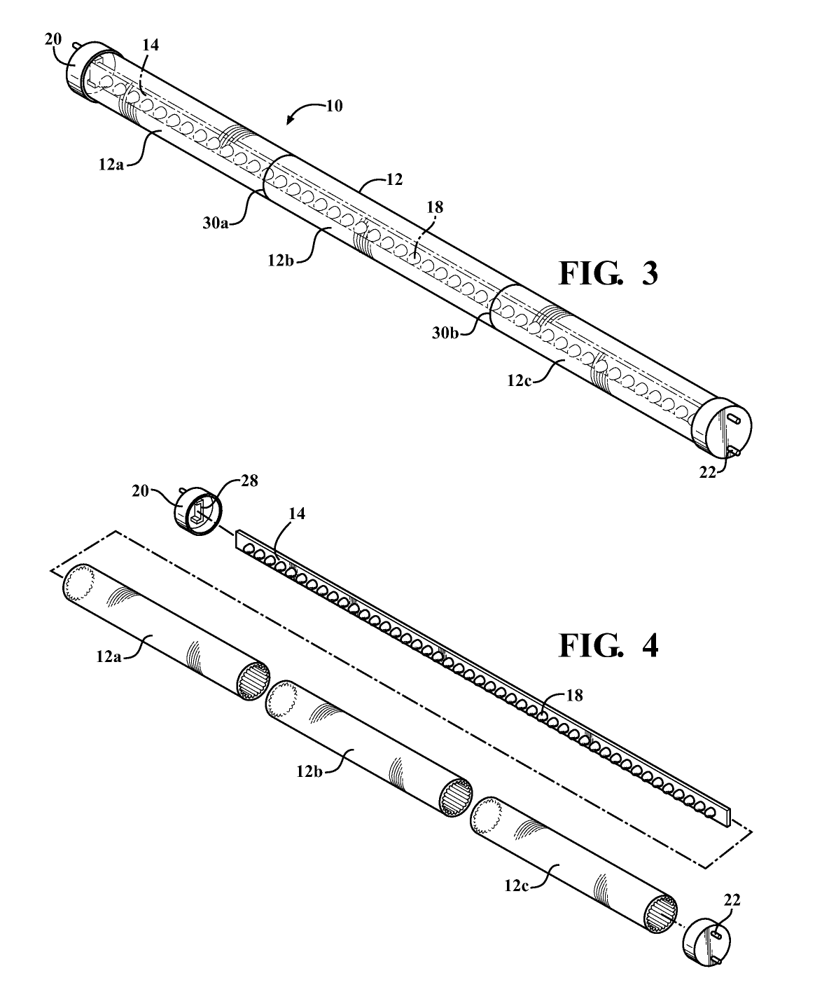

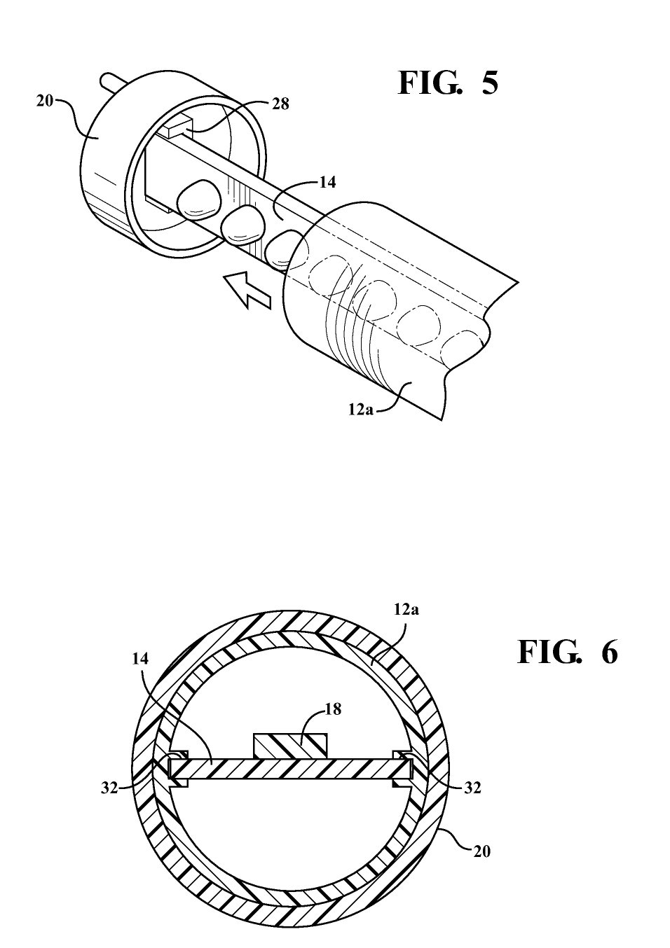

Assembling the light tubes 10 involves, in the case of FIG. 2, attaching an end cap 20 to one end of a housing segment 12a, inserting one end of the circuit board 14 into the housing segment 12a until the circuit board 14 contacts the end cap 20. The end cap 20 can have a raised portion 28 forming a slot within which the end of the circuit board 14 fits to hold the circuit board 14 in place. This is shown more clearly in FIG. 5. Housing segment 12b is slid over the other end of the circuit board 14 until it contacts housing segment 12a. The other end cap 20 is then placed on the open end of housing segment 12b. The seam 30 of housing segments 12a and 12b is joined by, for example, ultrasonic welding. When the light tube 10 of FIG. 3 is manufactured, seams 30a and 30b are similarly joined after the components are assembled. Other means of joining the seam or seams of the housing known to those skilled in the art can be used as desired or required. After assembly, the light tubes 10 of FIGS. 1 and 3 can be installed in a fixture by engaging the end caps 20 with the fixture, with the circuit board 14 oriented to face the area to be illuminated.

Additionally, while the illustrated circuit board 14 is shown in FIG. 5 to be received by the slot 28 in the end cap 20, the circuit board 14 can be slidably engaged with the housing 12, as shown is FIG. 6, and secured by tabs 32. The housing segments 12a, 12b, 12c can have tabs 32 that project from the segment on opposite sides of the circuit board 14. The tabs 32 are preferably formed integrally with the segment by, for example, extruding the housing segments 12a, 12b, 12c to include the tabs 32. Each tab 32 can extend the entire length of a housing segment, though a series of discrete tabs can alternatively be used to secure the circuit board 14. The circuit board 14 can alternatively be clipped, adhered, snap- or friction-fit, screwed or otherwise connected to the housing segments.

Although the circuit board 14 is shown in FIGS. 1-4 as an integral, one-piece circuit board, multiple circuit board sections can be joined by bridge connectors to create the circuit board of the appropriate length. If multiple circuit board sections are used, the assembly of the light tube may involve inserting a first circuit board section into a housing segment, joining another circuit board segment to the first segment with a bridge connector, sliding another housing segment over the last inserted circuit board segment and continuing until the assembly is complete with the end caps at each end of the overall light tube.

The above-described examples have been described in order to allow easy understanding of the invention and do not limit the invention. On the contrary, the invention is intended to cover various modifications and equivalent arrangements, whose scope is to be accorded the broadest interpretation so as to encompass all such modifications and equivalent structure as is permitted under the law.

1. A LED-based light mountable in a fluorescent light fixture, the LED-based light comprising:
a housing having a plurality of joined segments defining an interior cavity;
a circuit board; and
at least one LED mounted on the circuit board, wherein
the circuit board with the at least one LED is located in the interior cavity formed by the plurality of segments of housing placed end to end.

2. The LED-based light of claim 1 wherein:
the plurality of housing segments each have a constant diameter.

3. The LED-based light of claim 1 wherein:
each of the housing segments have a linear shape from end-to-end.

4. The LED-based light of claim 1 wherein:
at least one housing segment has a non-linear shape.

5. The LED-based light of claim 1 wherein:
the plurality of the housing segments have an equal length.

6. The LED-based light of claim 1 wherein:
at least one of the housing segments has a different length than the other housing segments.

7. The LED-based light of claim 1 wherein:
each of the housing segments has first and second opposed open ends.

8. A method of manufacturing a LED-based light comprising the steps of:
providing a housing segment having a first end and an opposed, second end;
coupling an end cap to the first end of the housing segment;
inserting a circuit board through the second end of the housing segment until it contacts the end cap;
sliding at least one additional housing segment over the circuit board until an entire length of the circuit board is enclosed;
placing a second end cap on a remaining open end of a last housing segment; and
joining seams created between the housing segments.

9. The method of claim 8 further comprising the step of:
engaging the second end cap with one end of the circuit board.

10. The method of claim 8 further comprising the step of:
forming the circuit board of a plurality of circuit boards segments;
inserting one circuit board segment through the second end of the housing segment until it contacts the end cap; and
alternating by sliding at least one additional housing segment over a circuit board segment and sliding at least one additional circuit board segment through the housing segments into contact with another circuit board segment.

11. A method of manufacturing a LED based-light comprising the steps of:
coupling an end cap to one end of a circuit board;
sliding a housing segment having a first end and an opposed second end over the circuit board until the first end of the housing segment engages the first end cap;
coupling at least one additional housing segment to the first housing segment until a desired overall housing length is achieved;
placing a second end cap on the open end of the endmost housing segment; and
joining the seams created between the housing segments.

12. The method of claim 11 further comprising the steps of:
forming the circuit board of a plurality of circuit boards segments;
inserting one circuit board segment through the second end of the housing segment until it contacts the end cap; and
alternating by sliding at least one additional housing segment over a circuit board segment and sliding at least one additional circuit board segment through the housing segments into contact with another circuit board segment.
